(19) United States
(12) Patent Application Publication
(10) Pub. No.: US 2004/0117433 A1
(43) Pub. Date: Jun. 17, 2004

(54) Cooperative computer network

(76) Inventor: Gary A. Walpert, Weston, MA (US)

Correspondence Address: HALE AND DORR LLP, 300 PARK AVENUE, NEW YORK, NY, 10022, US

(21) Appl. No.: 10/720,426

(22) Filed: Nov. 24, 2003

Related U.S. Application Data
(63) Continuation of application No. 08/505,469, filed on Jul. 21, 1995, now abandoned.

(51) Int. Cl. G06F 15/16

(52) U.S. Cl. 709/200

(57) ABSTRACT

A cooperative computer system interconnects the plurality of computers through a network. Each computer is able to execute a foreign computer program received from another computer on the network whenever the local computer has capacity to execute the received program based upon local computer operating requirements. The local computer returns to the foreign computer required information regarding execution of the foreign computer program. The execution of the foreign computer program at the local computer is enabled only when the effect on a local user is minimal. Once the foreign program is operating, it can be interrupted if the effect of its execution as perceived by the local user becomes other than minimal, and sufficient data and context information for continuing execution of an interrupted foreign program can be returned to the foreign computer for transmittal and completion of the interrupted program on a computer other than the local computer.

### BACKGROUND OF THE INVENTION

The invention relates generally to computer systems and in particular to a method and apparatus for more effectively utilizing a plurality of computers connected through a network.

As computers become more a part of daily life, they are found on substantial numbers of desks in the work environment, for example, law firms, accounting firms, and other professional and technical businesses. Most of the time, these computers are on, but are typically idle or underutilized. This idle or under utilized state is particularly prevalent in environments where the computer is used primarily for word processing and/or where the computer power sitting on the desk is one or more orders of magnitude greater than that needed by the user.

It is also a factor of high technology that many or most of the computers used in business are connected to each other through networks. This enables them to share databases, provide electronic mail between remote locations, and access, in some instances, either a central computer system or remote databases through telephone communications.

There also exists, in the corporate and professional world, the need for the biggest and the best. Accordingly, as noted above, a syndrome often prevails to buy computers having far greater computing capacity than what is needed by their user. The apparent basis is to provide everyone with a high capacity computer to prepare each user for “future” needs. Often those needs do not materialize, or the need to use a powerful machine is minimal. Thus, typically, the computers are operated at only a small fraction of their maximum capacity.

There are also available massively parallel computers, distributed computer systems, and other strategies for making use of a plurality of lower capacity computers or processors, to solve large problems. Under these various schemes, it is typical to allow all computers connected to a network or computer backplane to address a common database and/or to have common virtual memory addressing, and/or to provide an operating system which will break down one problem into many component problems, each problem to be solved by a separate computer on the network. This can occur whether the network is a series of spaced apart computers or a massively parallel computer with many small processor integrally connected in a single card rack, on a single board, or in a single chip. These distributed or parallel systems, however, do not address the issue of many machines which are not profitably and economically used, and which sit idle or underutilized.

Accordingly, it is an object of the present invention to increase the productivity of computers in whatever environment they may be, to make use of unused capacity in a computer network, and to further enhance the ability to solve problems, quickly and inexpensively, in a networked facility.

### SUMMARY OF THE INVENTION

The invention relates to operating a cooperative computer system for improving the efficiency of the entire system. The method features the steps of interconnecting a plurality of computers along at least one networking interconnection; executing at a local computer, a foreign computer program received from a foreign computer whenever the local computer has capacity to execute the received program based upon the local computer operating requirements; and returning to the foreign computer required information regarding execution of the foreign computer program.

In particular embodiments, the method features executing the foreign computer program only when the effect on a local user is minimal and interrupting operation of the foreign computer program to respond to a local user requirement. After the interruption, sufficient data and context information for continuing execution of the interrupted foreign computer program on a computer other than local computer is returned to the foreign computer.

In a multitasking system environment, the foreign computer program need not be interrupted and the program data and context information returned to the foreign computer in response to a local request. Rather, the method features changing the priorities of the multitasking system so that the effect on the local user is minimal.

The apparatus of the invention features a network circuitry for interconnecting a plurality of computers, a local computer for executing a foreign computer program received from a foreign computer whenever the local computer has capacity to execute the received program based upon local computer operating requirements and wherein the local computer will return to the foreign computer required information regarding execution of the foreign computer program.

The local computer executes the foreign computer program only when the effect on a local user is minimal and interrupts execution of the foreign computer program to respond to a local user requirement (unless it is operating in a multitasking environment). The local computer, after interrupting execution of the foreign computer program, returns to the foreign computer sufficient data, context and other information for continuing execution of the interrupted foreign program in a computer other than the local computer.

### BRIEF DESCRIPTION OF THE DRAWINGS

Other objects, advantages, and features of the invention will be apparent from the following description taken together with the drawings in which:

FIG. 1 is a schematic representation of a plurality of interconnected networks and their associated computers;

FIG. 2 is a schematic representation of a minimum configuration computer connected to the network;

FIGS. 3A and 3B are a flow chart of an operating system in accordance with a first particular embodiment of the invention; and

FIGS. 4A and 4B are a flow chart of a multitasking operating system in accordance with a second particular embodiment of the invention.

### DESCRIPTION OF PARTICULAR EMBODIMENTS OF THE INVENTION

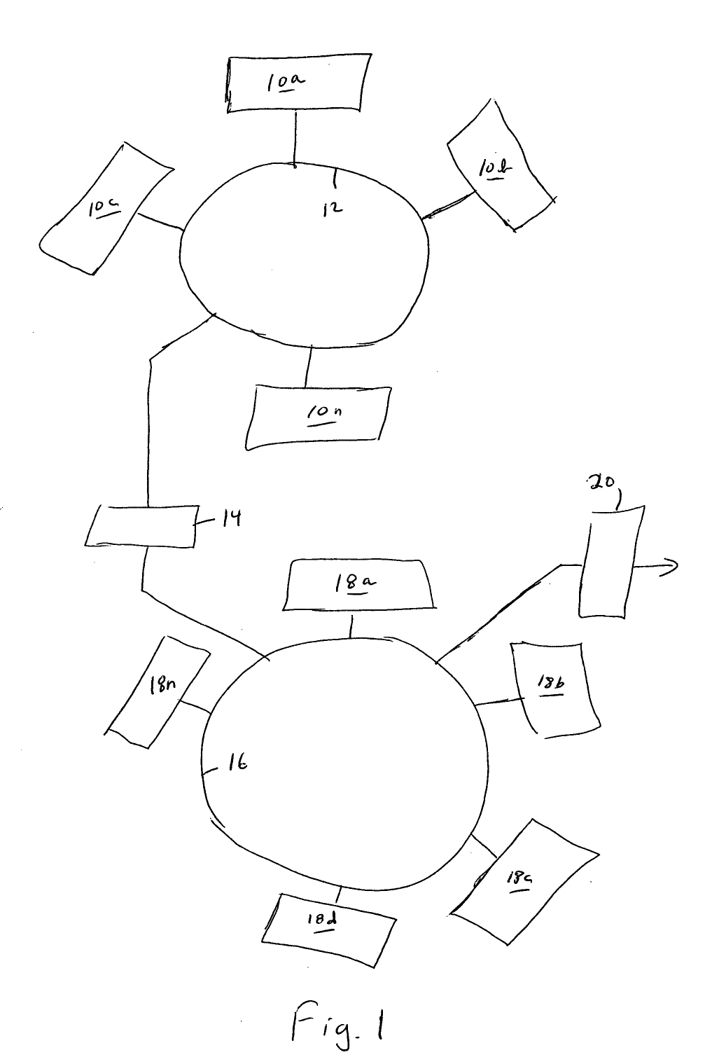

Referring to FIG. 1, a typical computer network configuration includes a plurality of computers 10a, 10b, . . . , 10n connected through a network 12, which can be, for example, an Ethernet, a token passing ring network, or any other network which can be used, for example, to connect a plurality of computers for intercommunications. Preferably, the network is a very high speed network, such as FDDI, operating at 100 mbs or more. In the illustrated embodiment, the network 12 is connected through a network interconnection circuitry 14 to a second network 16. The second network 16 has a second plurality of computers 18a, 18b, . . . , 18n connected thereto for communications with each other and, through network interconnection circuitry 14, the computers connected to network 12. The networking configuration can be extended, for example through a second network interconnection circuitry 20, which can be a telephone connection, to provide a large interconnection of networks, all capable of communications with one another.

In the particular preferred embodiment of the invention the computers 10 and 18 are all personal computers known as “PC's”. While in other embodiments of the invention, more powerful computers can be used such as the DEC VAX family of computers and the Sun, Hewlett-Packard, or IBM workstations, etc., in most present environments, it is the PC which is used most commonly in a network configuration and which generally operates at a relatively low percent of its capacity. (“PC” can relate to the so-called 8086, 8088, 286, 386, and 486 based machines and for purposes of this application to MacIntosh and Apple machines as well.) Accordingly, the network configuration can have a large surplus of capacity and thus can be advantageously operated, in accordance with the invention, to more efficiently perform substantially more computational work.

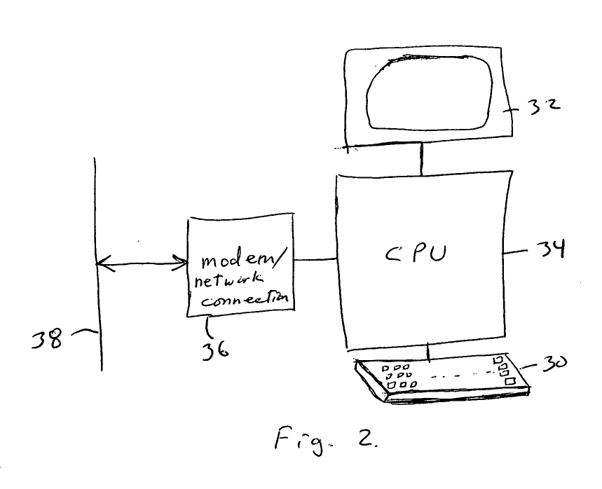

In the illustrated embodiment, each of the computers 10, referring to FIG. 2, is of a standard, and if desired basic, configuration including a keyboard 30, a monitor 32, a controlling central processing unit (CPU) 34, and a modem or network connection 36 for connection between the CPU and a network bus 38. The network bus, as noted above, can be any of the various networks presently known or to be developed as described below.

In accordance with the invention, referring to its general operation, if the computer, for example, computer 10a, has a plurality of tasks which it is responsible for performing, it would be desirable, rather than running those tasks either serially, or through multitasking (where each task receives perhaps only 10% or 15% of the CPU power), to run each of the tasks on a separate computer, that is to assign each task to a separate computer having available time and capacity, and to obtain the results from that separate computer(s) when the task is completed. It is also important, however, that the performance of the separate computer, from the viewpoint of its operator, not be impaired. Thus, for example, for a word processing application, the response time of the “separate” computer to its user must be substantially the same when it is running a foreign program, as when it is solely dedicated to its user.

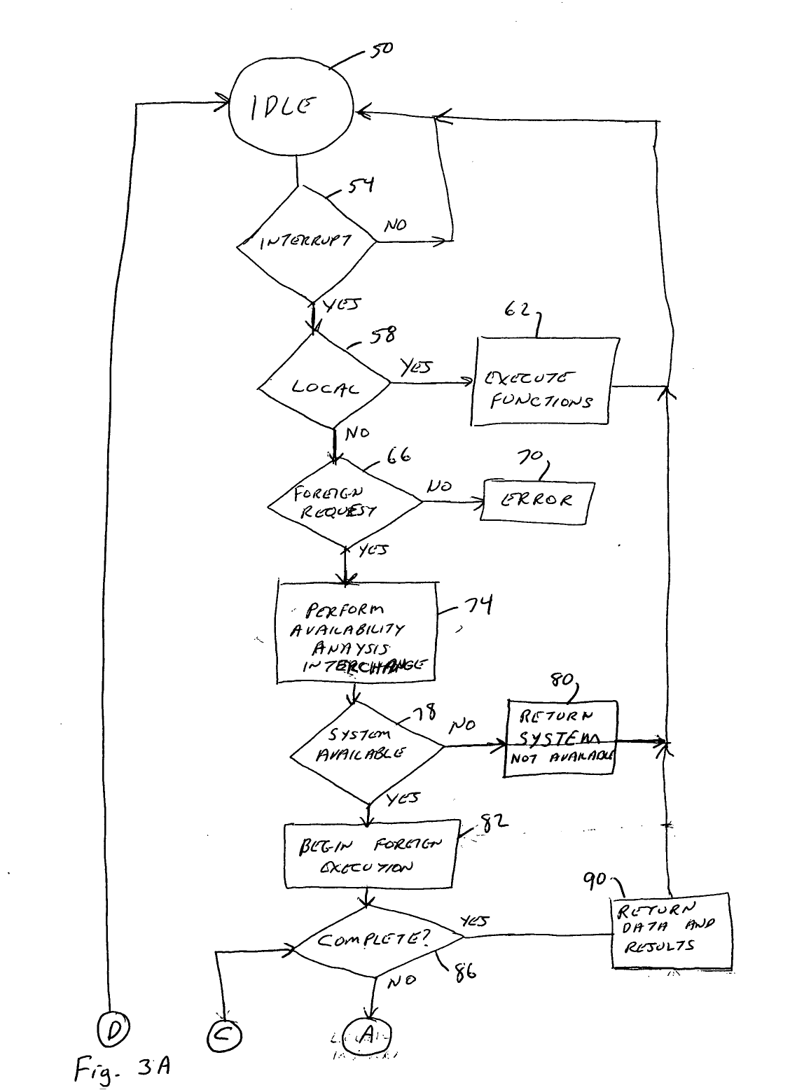

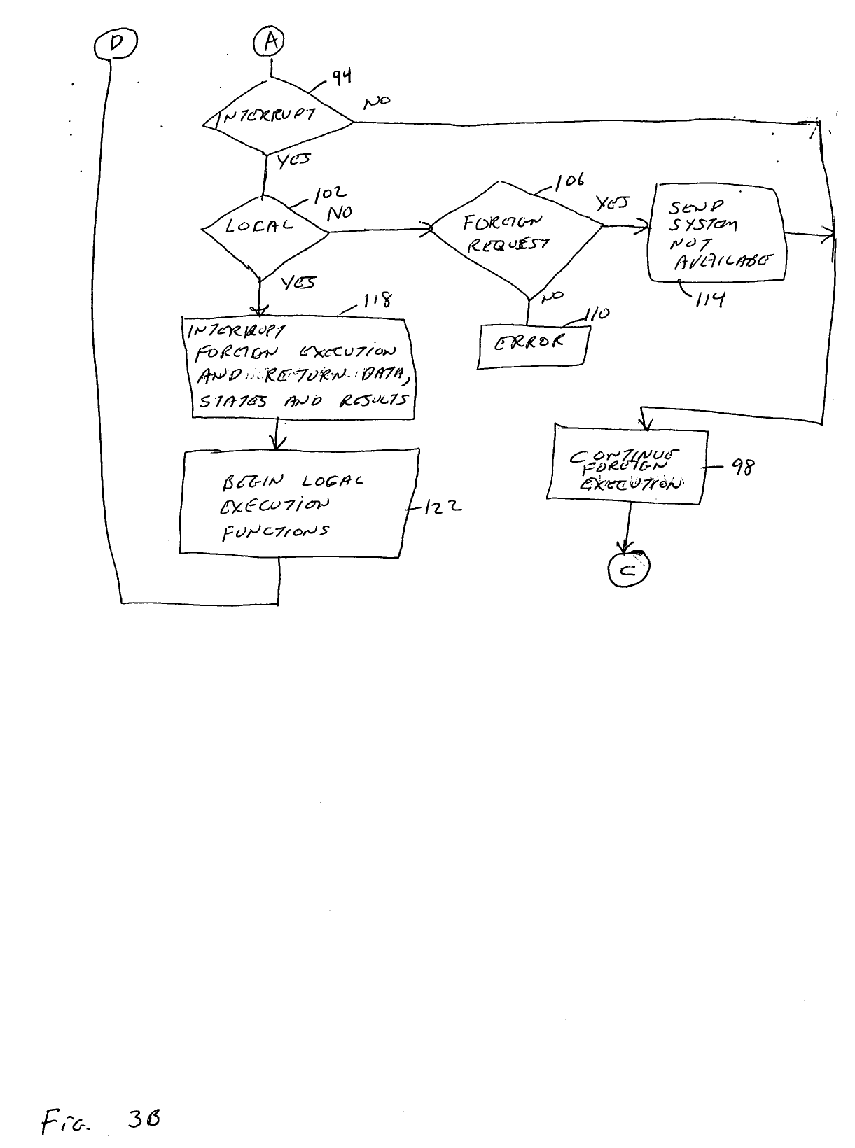

Thus, in accordance with a preferred embodiment of the invention, the operating system for each of the computers in the network is modified to enable the computer to execute programs provided by “foreign” computers while at the same time ensuring that the operation of the computer is not impaired as it is perceived by its user. Referring now to FIGS. 3A and 3B, in the illustrated embodiment of the invention, the operating system for each of the computers 10 and 18 will be substantially the same, functionally, for purposes of this invention, and operates in accordance with the flow chart of FIGS. 3A and 3B. In that operation, as noted above, each computer is, at some point, in its idle state. This may occur either at turn on, for example, or at a point in time where there is no program running on the computer other the resident background programs which require only a bare amount of CPU capacity. This can also occur, for example, when the computer is loaded with a word processing application but where there is no user input.

Once in this idle state 50, the operating system checks, at 54, to see whether there is an interrupt. If there is no interrupt, the system returns to the idle state 50. If there is an interrupt, the system first examines whether it is a locally generated interrupt, that is, whether it is an interrupt from either a local operating program or from the user at the keyboard. This occurs at 58. If the interrupt is local, the computer performs the required local functions at 62, and returns to its idle state 50. If the interrupt is not local, the operating system checks, at 66, to determine whether the interrupt is caused by a foreign request. If it is not a foreign request, an error condition occurs at 70. If it is a foreign request, (in accordance with the preferred embodiment of the invention, a “foreign request” is a request from a foreign computer to execute a program,) the requested computer performs an availability analysis at 74 to determine whether it is able to execute the program. Factors included in the availability analysis include computer compatibility and the program requirements, both in memory, speed, and peripheral equipment. (These factors are included in the “foreign request”.) For example, if ten megabytes of memory are required, the local program must determine whether that amount of memory is available to perform the foreign program. If the system determines that it cannot execute the foreign program, and hence is not available, as determined at 78, the local system at 80, returns a not available message to the foreign computer and returns to the idle state 50. If the local system is available to execute the foreign program, it receives all of the necessary and required information from the foreign computer (including the program and associated data) and begins execution of the program at 82.

To make the process substantially transparent to the user, a very high throughput network is preferably employed. The high capacity network allows substantial quantities of program information and data to be moved between computers so that only minimal delays due to intercomputer transfer are encountered. A request from a requesting computer is placed on the network and, in the preferred embodiment, is routed to the interconnect computers in a sequence determined by the connections to the network. Thus, for example, in a network operating in accordance with a token ring protocol, the request could be circulated around the network in the same order that the token is passed around the network. In other embodiments of the invention, other procedures for directing requests to the connected computers can be employed.

During execution of the foreign program, to ensure that the use of the computer to effect foreign program execution is transparent to its local user, the local computer performs a series of interrogations. It first, and continuously, checks, at 86, to determine whether execution of the foreign program has been completed. If it has, the results of the execution, including all data and other information required by the foreign computer, is returned to the foreign computer at 90 and the local computer returns to its idle state 50.

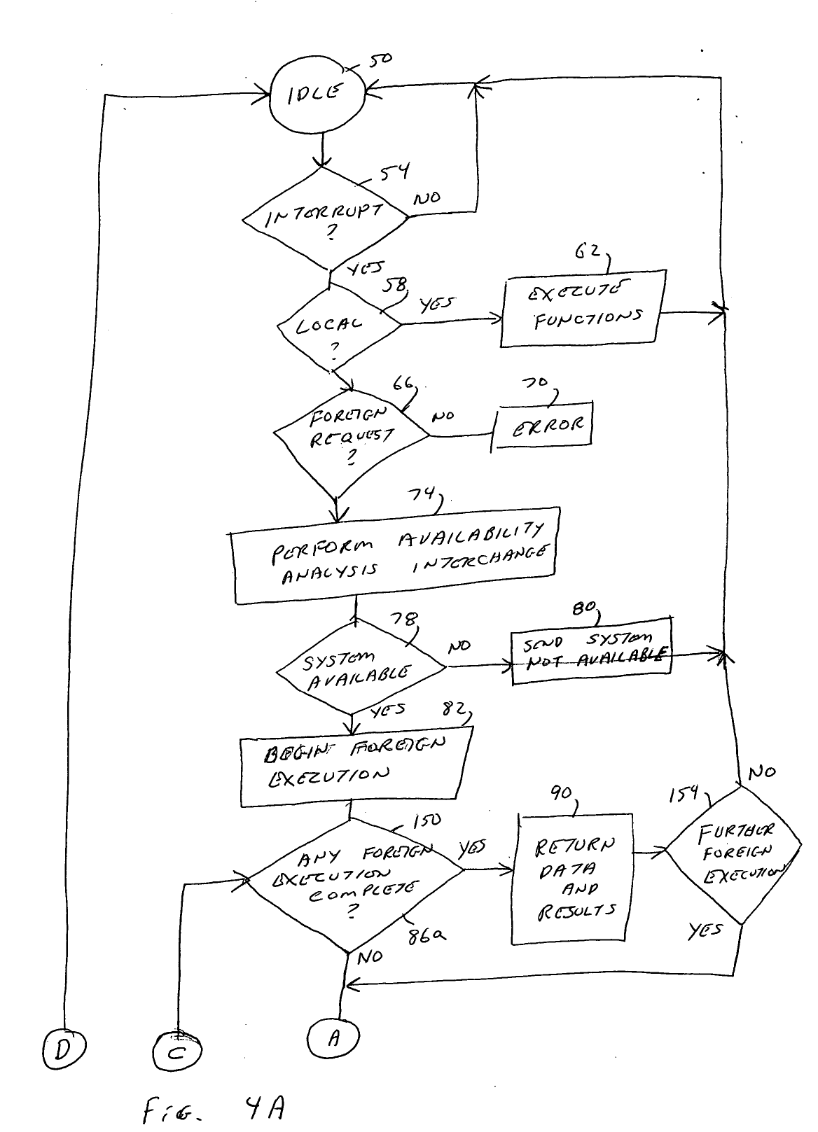

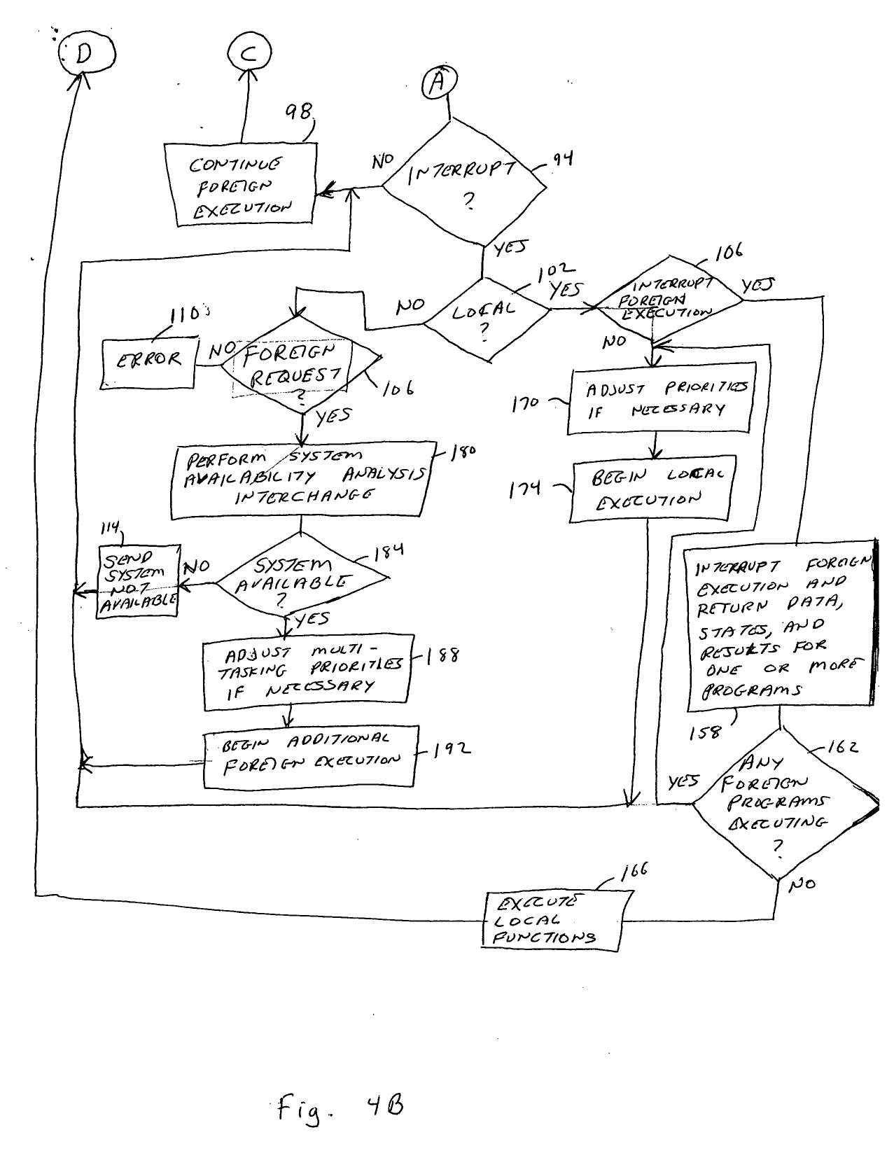

If the foreign program execution is not complete, the operating system checks at 94, for further interrupts. If there are none, the foreign program execution continues at 98. If there has been an interrupt, the operating system checks, at 102, whether it was a local interrupt. If it was not a local interrupt, it checks at 106 to determine whether it was a foreign interrupt. If was not a foreign interrupt, an error condition is indicated at 110; while if it is a foreign interrupt, the system in the illustrated embodiment sends the foreign computer a “not available” message over the network at 114 and returns to continue execution of the foreign program which it had been executing. (Note, however, that in a multitasking environment, as described in detail in connection with FIGS. 4A and 4B, the local computer may be able to run two or more foreign programs simultaneously. Accordingly, in a multitasking environment, the local computer will again need to check its availability before deciding whether to accept the incoming foreign request.)

If the interrupt is a local interrupt, primary attention, in this illustrated embodiment, is given to ensuring that the local user receives first priority in the use of his computer. Accordingly, the foreign executing program is interrupted at 118 and the data and results to date, and the state of the program is. returned to the foreign computer, if necessary, so that the program can be completed on another machine. Thereafter the local execution function is initiated at 122, and if the foreign program was returned to the foreign computer, the computer returns to the idle state 50.

In some computer systems, multitasking will be available. Under multitasking, the computer can execute more than one computer program at a time, each program time sharing the computer CPU. In the event multitasking is available, in accordance with the preferred embodiment of the invention, priority is given to the user program so that the response time which the user experiences, even when there is a foreign program being executed by the machine, is not noticeably worse than that which is experienced when the user's programs is operating by itself. Accordingly, in a multitasking system, instead of needing to interrupt the foreign executing program when a local interrupt is received, the computer system, in the preferred embodiment, merely changes its priorities so that the local user is effectively unaware that the foreign program is executing.

Referring to FIGS. 4A and 4B, the operating system for each of the computers 10 and 18 which incorporates a multitasking environment initially operates substantially the same, functionally, as that of the operating system illustrated in FIGS. 3A and 3B. Accordingly, like operating states and steps have been denoted by the same reference numeral, where possible, in the figures. The divergence of operation begins when the multitasking operating system checks, at 150, to determine whether any then operating foreign computer program has completed execution. If any has completed execution, the results from the completed computer program are returned to the foreign computer, at 90, and the system then checks at 154 to determine whether there are any other foreign computer programs executing on the system. If there are none, the system returns to the idle state, while if there are any further executing foreign programs, the system checks at 94, for any further interrupts. The system also checks at 94 for further interrupts if no foreign program has completed execution. If there are no further interrupts, foreign execution is continued at 98, and a check is made at 150 for completion of one or more of the foreign programs.

If there is an interrupt at 94, and it is a local interrupt as checked at 102, the system will interrupt foreign execution at 106 if the local computer does not have the capacity to handle the local operations with minimal impairment of local user operation. By “minimal impairment”, it is generally meant that the operation of the foreign executing programs on the local computer is substantially transparent to the local user. If foreign execution must be interrupted, the system will return the data context information, state information, and program results to the foreign computer for one or more of the then executing foreign programs, as necessary. This is indicated at 158. The system then checks, at 162, to determine whether any further foreign programs are executing. If none are executing, the local functions are executed at 166 after which the system returns to its idle state. If any foreign programs continue to be executed by this multitasking system, the multitasking priorities are adjusted as necessary, at 170, and local execution is begun at 174. The priorities which are adjusted typically provide more CPU access to the local program in order to ensure that the impairment to local user operation is not objectionable. The system then continues executing the foreign programs at 98.

As noted in FIG. 4B, if there is no need to interrupt foreign execution at 106, then the priorities are adjusted at 170 and local execution begins at 174.

If the interrupt were not a local interrupt, the interrupt is checked at 106 to ensure that it is a foreign interrupt. If it is not a foreign interrupt, an error condition obtains at 110. In response to a foreign interrupt, the system performs a system analysis to determine its availability for executing the pending foreign program. This analysis is performed at 180. If the system is available, as determined at 184, the multitasking priorities are adjusted, as noted above, at 188, and the new foreign program begins execution at 192. If the system is not available at 184, the system sends a not available message to the foreign computer at 114. The foreign programs executing on the system are continued at 98.

As computer networking becomes more sophisticated, and the use of fiber optics replaces the relatively band limited coaxial cable, the ability to send large quantities of data and programs from one computer to another at very high throughputs will increase substantially. Under these more favorable circumstances, there should be no substantial detriment to moving programs, their related data and results, and context states from one computer to another to achieve the goals of the present invention, that is, to effect a higher productivity and better use of the computer environment,. while at the same time, enabling the user to operate his system without impaired response time due to execution of other (foreign) users' programs, operating on his system.

Additions, subtractions, deletions and other modifications of the described embodiments will be apparent to those practiced in the art and are within the scope of the following claims.

What is claimed is:

1. A method for operating a cooperative computer system comprising the steps of
interconnecting a plurality of computers along at least one networking interconnection,
executing at a local computer a received computer program from a foreign computer when the local computer has capacity to execute said received program based upon local computer operating requirements, and
returning to the foreign computer required information regarding execution of the foreign computer program.

2. The method of claim 1 further comprising the step of
executing said foreign computer program only when the effect on a local user is minimal.

3. The method of claim 2 further comprising the steps of
interrupting execution of said foreign computer program to respond to a local user requirement.

4. The method of claim 3 further comprising the step of
returning to the foreign computer, after said interruption, sufficient data and context information for continuing execution of said interrupted foreign program on a computer other than the local computer.

5. The method of claim 2 further comprising the step of
adjusting priorities in a multitasking environment at the local computer for minimizing the effect on the local user.

6. A method for operating a cooperative computer system comprising the steps of
interconnecting a plurality of computers along at least one networking interconnection,
executing at a local computer a received computer program from a foreign computer when the local computer has capacity to execute said received program based upon local computer operating requirements and when the effect on a local user is minimal, and
interrupting execution of said foreign computer program when necessary to respond to a local user requirement,
returning to the foreign computer, after said interruption, sufficient data and context information for continuing execution of said interrupted foreign program on a computer other than the local computer, and
returning to the foreign computer, when there is no interruption, required information regarding execution of the foreign computer program..

7. The method of claim 6 further comprising the step of
adjusting priorities in a multitasking environment at the local computer for minimizing the effect on the local user.

8. An apparatus for operating a cooperative computer system comprising
means for interconnecting a plurality of computers along at least one networking interconnection,
means for executing at a local computer a received computer program from a foreign computer when the local computer has capacity to execute said received program based upon local computer operating requirements, and
means for returning to the foreign computer required information regarding execution of the foreign computer program.

9. The apparatus of claim 8 further comprising
means for executing said foreign computer program only when the effect on a local user is minimal.

10. The apparatus of claim 9 further comprising
means for interrupting execution of said foreign computer program to respond to a local user requirement.

11. The apparatus of claim 10 further comprising
means for returning to the foreign computer, after said interruption, sufficient data and context information for continuing execution of said interrupted foreign program on a computer other than the local computer.

12. The apparatus of claim 9 wherein said interconnecting means comprises a fiber optic network.

13. The apparatus of claim 12 wherein said network operates according to a token passing protocol.

14. An apparatus for operating a cooperative computer system comprising
means for interconnecting a plurality of computers along at least one networking interconnection,
means for executing at a local computer a computer program received from a foreign computer when the local computer has capacity to execute said received program based upon local computer operating requirements and when the effect on a local user is minimal,
means for interrupting execution of said foreign computer program to respond to a local user requirement,
means for returning to the foreign computer, after said interruption, sufficient data and context information for continuing execution of said interrupted foreign program on a computer other than the local computer, and
means for returning to the foreign computer, when there is no interruption, required information regarding execution of the foreign computer program.
